(19) United States
(12) Patent Application Publication
(10) Pub. No.: US 2025/0346477 A1
(43) Pub. Date: Nov. 13, 2025

(54) DISPENSING FUNNEL FOR A DRINK MAKER

(71) Applicant: SharkNinja Operating LLC, Needham, MA (US)

(72) Inventors: Michael Lerman, Providence, RI (US); Jennifer Andrews, Boston, MA (US); Alexander Mularski, Auburn, MA (US)

(73) Assignee: SharkNinja Operating LLC, Needham, MA (US)

(21) Appl. No.: 18/658,434

(22) Filed: May 8, 2024

(51) Int. Cl. B67D 1/08; B67D 1/00; B67D 1/14

(52) U.S. Cl. CPC B67D 1/0887; B67D 1/0047; B67D 1/0858; B67D 1/1477; B67D 2210/00125

(57) ABSTRACT

A funnel for covering a dispenser assembly of a frozen drink maker has an upper portion attachable to the dispenser assembly. The upper portion is configured to allow the dispenser assembly to selectively uncover a spout of the frozen drink maker to dispense a drink product from the spout in a horizontal direction. A lower portion of the funnel extends downward from the upper portion. The lower portion includes an inner wall defining a channel. The channel has a first region configured to direct a flow of the drink product at an angle relative to a front panel of the frozen drink maker, and a second region configured to direct the flow of the drink product parallel to the front panel in a substantially vertically downward direction.

### TECHNICAL FIELD

The present disclosure relates to a frozen drink makers and, more particularly, to a frozen drink maker including a low maintenance dispense system.

### BACKGROUND

Frozen drink makers, which may also be referred to as semi-frozen beverage makers or crushed-ice drink makers, typically include a transparent tank or mixing vessel in which a drink product is received and processed, including being cooled, often transforming the drink product from a pure liquid (or a combination of a liquid and portions of ice) to a frozen or semi-frozen product, such as, for example, a granita, slush drink, smoothie, ice cream, or other frozen or semi-frozen product, which is then dispensed. The cooled product is typically dispensed through a tap, spigot or dispenser located at the front and near the bottom of the vessel. Thus, the term “frozen drink maker” as used herein is not limited to a device that only makes drinks or frozen drinks but includes devices that cool received drink products to produce cooled outputs in any of a variety of cooled, frozen, and semi-frozen forms. A drink product typically consists of a mixture of water or milk, a syrup, flavoring powders, or other additives that give the drink product the desired taste and color.

Some existing frozen drink makers include a mixing system within the mixing vessel having a mixing blade or auger that is rotated by a motor via a drive shaft and drive assembly. Some existing frozen drink makers include a refrigeration system having a compressor, a condenser, and an evaporator (i.e., chiller) for receiving refrigerant from the compressor where the evaporator is located adjacent to or within the mixing vessel to cool the drink product during processing. Typically, a dispensing mechanism uses a plunger seal to open and close a spout on the frozen drink maker to dispense the drink product.

Some existing frozen drink makers include a controller that controls operations of the frozen drink maker related to making drink products, including the temperature of drink products during processing.

### SUMMARY

The disclosure describes a dispensing funnel for a frozen drink maker that is configured to enhance the thickness, consistency, and visual appearance of the dispensed drink product. The funnel has an enclosed geometry that directs the drink product substantially vertically downward at a known and repeatable location.

In some implementations, a funnel for covering a dispenser assembly of a frozen drink maker of this disclosure includes an upper portion configured to cover a spout of the frozen drink maker that dispenses a drink product from the frozen drink maker in a horizontal direction, and a lower portion extending downward from the upper portion. The lower portion includes an inner wall defining a channel. The channel includes a first region configured to direct a flow of the drink product at an angle relative to a front panel of the frozen drink maker, and a second region configured to direct the flow of the drink product in an at least substantially vertically downward direction.

In further implementations, the funnel is configured to position the channel below the spout. In implementations, the angle is between about 15 and 40 degrees relative to the front panel. In implementations, the second region of the channel includes a dispenser opening. In implementations, the channel is configured to direct the flow of the drink product from the spout through the dispenser opening. In implementations, a diameter of the dispenser opening is selected to be wider than a diameter of the spout. In implementations, a diameter of the dispenser opening is between about 5% and 20% wider than a diameter of the spout. In implementations, a shape of the dispenser opening is circular. In implementations, the second region of the channel is at least partially defined by the inner wall. In implementations, the second region of the channel is further defined by an outer wall extending substantially parallel to the front panel. In implementations, the front panel of the frozen drink maker is arranged in an at least substantially vertically downward direction. In implementations, the upper portion of the funnel is removably attachable to a dispenser assembly of the frozen drink maker.

One of ordinary skill will recognize that the systems, methods, and devices described herein may apply to other types of food products such as to the making and/or processing of, without limitation, ice cream, frozen yogurt, other creams, and the like. While the present disclosure describes examples of a drink maker processing various frozen and/or semi-frozen drink products, the systems, devices, and methods described herein are not limited to such drink products and are capable of processing and/or making other types of drink products such as cooled drink products and/or chilled drink products. The terms “mix,” “mixed” or “mixing” as used herein are not limited to combining multiple ingredients together, but also include mixing a drink product or liquid having a single or no added ingredients. For example, a drink product may consist of only water that is mixed by a dasher during processing, i.e., portions of the water are churned and/or intermingled as the dasher rotates. This may, for example, advantageously enable a more uniform temperature of the water and/or liquid as a whole within the mixing vessel by intermingling portions of the water and/or liquid having different temperatures.

A reading of the following detailed description and a review of the associated drawings will make apparent the advantages of these and other structures. Both the foregoing general description and the following detailed description serve as an explanation only and do not restrict aspects of the disclosure as claimed.

### BRIEF DESCRIPTION OF THE DRAWINGS

Reference to the detailed description, combined with the following figures, will make the disclosure more fully understood, wherein:

FIG. 1 shows a perspective view of a frozen drink maker, according to an implementation of the disclosure;

FIG. 2 shows a view of various internal components within the housing and mixing vessel of the frozen drink maker of FIG. 1, according to an implementation of the disclosure;

FIG. 3 shows a front view of the frozen drink maker of FIG. 1, according to some implementations of the disclosure;

FIG. 4 is a block diagram of an example of a control system of the frozen drink maker of FIG. 1, according to some implementations of the disclosure;

FIGS. 5A and 5B show a dispensing assembly for dispensing a drink product from the frozen drink maker, according to some implementations of the disclosure; and

FIGS. 6A-6L show a dispensing funnel for the dispensing assembly of FIGS. 5A and 5B, according to an implementation of the disclosure.

### DETAILED DESCRIPTION

In the following description, like components have the same reference numerals, regardless of different illustrated implementations. To illustrate implementations clearly and concisely, the drawings may not necessarily reflect appropriate scale and may have certain structures shown in somewhat schematic form. The disclosure may describe and/or illustrate structures in one implementation, and in the same way or in a similar way in one or more other implementations, and/or combined with or instead of the structures of the other implementations.

In the specification and claims, for the purposes of describing and defining the invention, the terms “about” and “substantially” represent the inherent degree of uncertainty attributed to any quantitative comparison, value, measurement, or other representation. The terms “about” and “substantially” moreover represent the degree by which a quantitative representation may vary from a stated reference without resulting in a change in the basic function of the subject matter at issue. Open-ended terms, such as “comprise,” “include,” and/or plural forms of each, include the listed parts and can include additional parts not listed, while terms such as “and/or” include one or more of the listed parts and combinations of the listed parts. Use of the terms “top,” “bottom,” “above,” “below”, “inner,” “outer,” and the like helps only in the clear description of the disclosure and does not limit the structure, positioning and/or operation of the disclosure in any manner.

The application, in various implementations, addresses deficiencies associated with dispensing a drink product from a home-use machine. Unlike commercial machines, where the thickness and flow rate of a drink product being dispensed is generally constant, in a home machine where the consumer can change the ingredients and processing temperatures of the drink product, the thickness and flow rate of the drink product may vary. In a machine where the drink product is initially dispensed in a horizontal direction, the location and flow rate of the subsequent downward trajectory of the dispensed product can thus vary based on the variable thickness and flow rate of the drink product. As a result, a user cannot always predict the proper placement of a drink cup underneath the dispensing assembly, which may result in inadvertent spills from the machine.

An additional complication of home use machines is that the flow of the drink product of the machine depends on how much drink product is in the machine. When the machine is full, the drink product will dispense faster and more continuously. However, when the machine has a smaller volume (e.g., a single serving), the drink product will dispense much slower, making the dispense of the drink product less predictable. Finally, a non-uniform thickness of the product as it is driven towards the dispenser by a rotating dasher may be less visually appealing to the user.

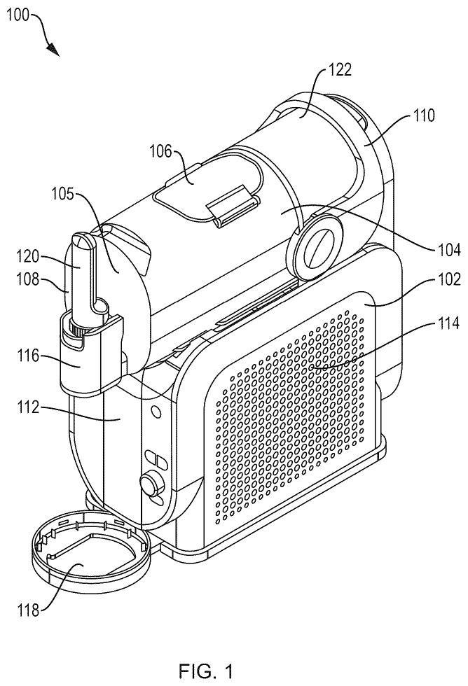

FIG. 1 shows a perspective view of a frozen drink maker 100 according to an illustrative implementation of the disclosure. The frozen drink maker 100 includes a housing 102 and mixing vessel 104. The housing 102 may include user interface 112 for receiving user inputs to control frozen drink maker 100 and/or to output or display information. User interface 112 may include one or more buttons, dials, switches, touchscreens, indicators, LEDs, and the like. User interface 112 may display status information including for example, a temperature of a drink product within mixing vessel 104, an indicator of a recipe and/or program currently being implemented, a timer associated with the progress of a recipe and/or program in progress and/or currently being implemented. User interface 112 may provide indicators and/or warnings to users regarding, for example, when a recipe is complete or when a user is expected to perform an action associated with processing a drink product. User interface 112 may include a selectable menu of drink types (e.g., recipes) and/or programs for different types of drink products such as, without limitation, granita, smoothie, margarita, daiquiri, pina colada, slushie, cocktail, frappe, juice, diary, milk shake, cool drink, semi-frozen drink, frozen drink, and the like.

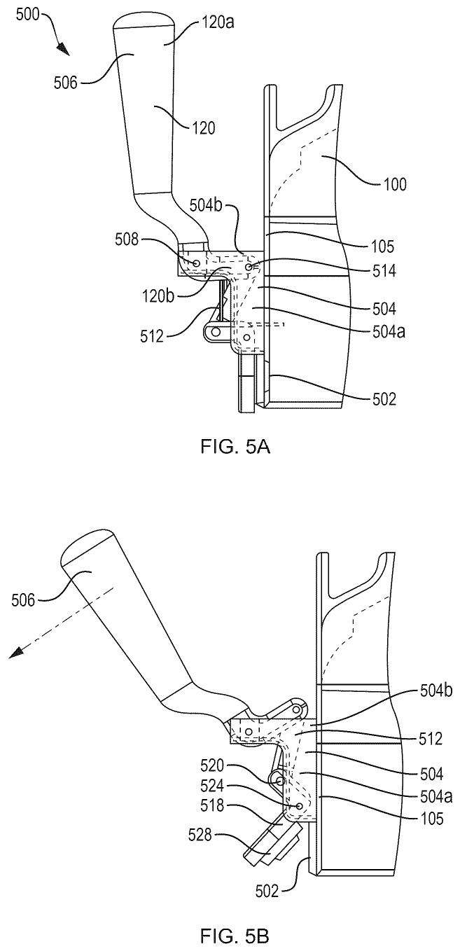

The housing 102 may include a panel (e.g., a removable panel) 114 along a side of the housing 102. Panel 114 may include a plurality of openings that facilitate air flow to aid in cooling components within housing 102. Housing 102 may include upper housing section 122 that is arranged to couple with a rear end of mixing vessel 104 when mixing vessel 104 is attached to housing 102. Mixing vessel 104 may include walls, or a portion thereof, that are transparent to enable a viewer to see a drink product within mixing vessel 104 during processing. Mixing vessel 104 may include pour-in opening 106 whereby mixing vessel 104 can receive ingredients for processing a drink product within mixing vessel 104. FIG. 1 shows pour-in opening (not shown) in a closed configuration with a cover 106 sealing the opening. The cover 106 may be detachably removable or moveable to open or close the opening. Pour-in opening may include a safety grate (not shown) to inhibit a user from reaching into mixing vessel 104 when the cover 106 is not installed. Mixing vessel 104 may include a dispenser assembly 108 having a user handle 120, a spout 502 (FIG. 5A), and a spout cover 116, which, in addition to covering a spout of the mixing vessel 104, also may serve as a shroud that visually occludes the spout, a splash guard, and/or a funnel that directs the flow of the drink product (frozen or otherwise) from the vessel 104. Dispenser assembly 108 may be attached to a vertical front panel 105 and may enable a user, by pulling down on handle 120, to open the spout, connected to a wall of mixing vessel 104, to dispense a processed (e.g., cooled) drink product from mixing vessel 104. The user can close the spout by pushing handle 120 back to its upright position (shown in FIG. 1) and, thereby, stop the dispensing of the processed drink product.

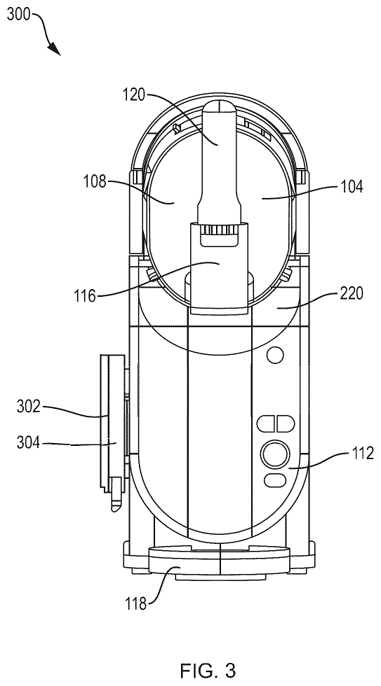

The frozen drink maker 100 may include a lever 110 that enables a locked coupling of mixing vessel 104 to housing 102 including upper housing section 122. FIG. 1 shows lever 110 in the locked and/or closed position whereby mixing vessel 104 is engaged and/or coupled to housing 102 and upper housing section 122. In the closed and/or engaged position, lever 110 ensures that there is a water-tight seal to prevent leakage of drink product from mixing vessel 104. Lever 110 may be placed in the closed, coupled, and/or engaged position by sliding mixing vessel 104 against upper housing section 122 and then rotating lever 110 in a clockwise direction until its handle rests on or about the top surface of upper housing section 122. Mixing vessel 104 can be disengaged and/or decoupled from housing 102 and upper housing section 122 by pulling and/or rotating lever 110 in a counterclockwise direction (from the perspective of FIG. 1) toward the front of mixing vessel 104, which causes lever 110 to release mixing vessel 104. Once released and/or decoupled, mixing vessel 104 may slide in a forward direction (away from upper housing section 122) to be fully detached and/or removed from housing 102. Mixing vessel 104 may include a radial seal and/or face seal. The face seal may provide an improved seal based on compression provided by lever 110 pushing mixing vessel 104 laterally against a wall of upper housing section 122. Mixing vessel 104 may include a circular and/or cylindrical opening at its rear end that couples mixing vessel 104 to upper housing section 122. An interlock switch may be implemented at the upper housing section 122 that is activated when mixing vessel 104 is coupled to upper housing section 122 that prevents activation of drive motor 208 unless vessel 104 is coupled to upper housing section 122. This ensures that a user is not exposed to a moving dasher 204. Frozen drink maker 100 may also include drip tray 118 being positioned below dispenser assembly 108 and arranged to collect any drink product that is not properly dispensed from mixing vessel 104 to, for example, a user cup. Drip tray 118 may be attachably removable from it operational position shown in FIG. 1. For example, water tray 118 may mounted and/or stored on a side panel of housing 102 as illustrated in FIG. 3 as water tray 304.

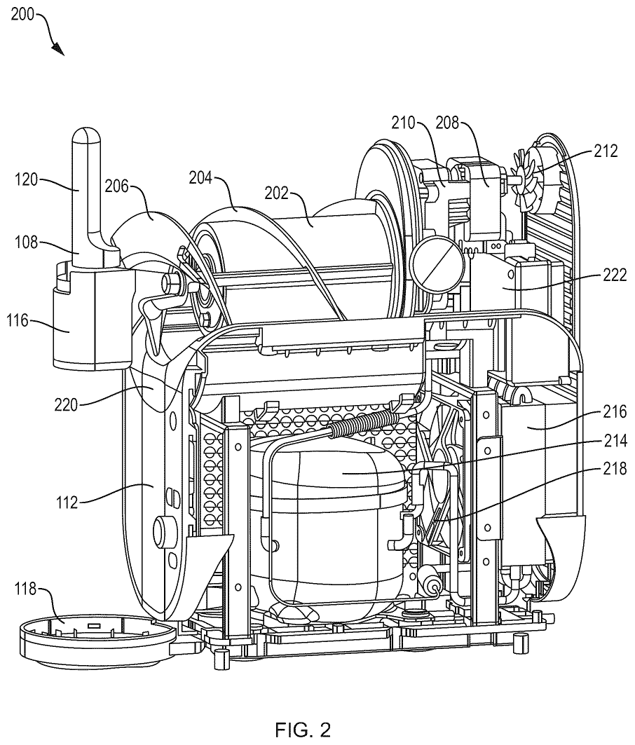

FIG. 2 shows a view 200 of various internal components within housing 102 and mixing vessel 104 of frozen drink maker 100 of FIG. 1. Frozen drink maker 100 includes a cylindrical evaporator 202 that is surrounded by an auger and/or dasher 204. Dasher 204 may include one or more mixing blades and/or protrusions that extend helically around evaporator and/or chiller 202. Dasher 204 may be driven to rotate by a central drive shaft within mixing vessel 104. The drive shaft may be surrounded by evaporator 202. However, in various implementations, evaporator 202 does not rotate. The drive shaft may be coupled via a gear assembly 210 to a drive motor 208. In some implementations, drive motor 208 is an AC motor, but another type of motor may be used such as, without limitation, a DC motor. Drive motor 208 may include a motor fan 212 arranged to provide air cooling for motor 208. While FIG. 2 shows an implementation where drive motor 208 is not coaxially aligned with the drive shaft used to rotate dasher 204, in other implementations, motor 208 can be aligned coaxially with the drive shaft. During processing of a drink product, motor 208 may be continuously operated at a one or more speeds to drive continuous rotation of dasher 204 and, thereby, provide continuous mixing of the drink product within mixing vessel 104. In some implementation, the rotation of the dasher 204 causes the helically arranged blades to push the cooling drink product to the front of the mixing vessel 104. During the processing, portions of the drink product may freeze against the surface of the evaporator as a result of being cooled by the evaporator. In some implementations, the blades of the rotating dasher 204 scrape frozen portions of the drink product from the surface the evaporator while concurrently mixing and pushing the cooling drink product towards the front of the mixing vessel 104.

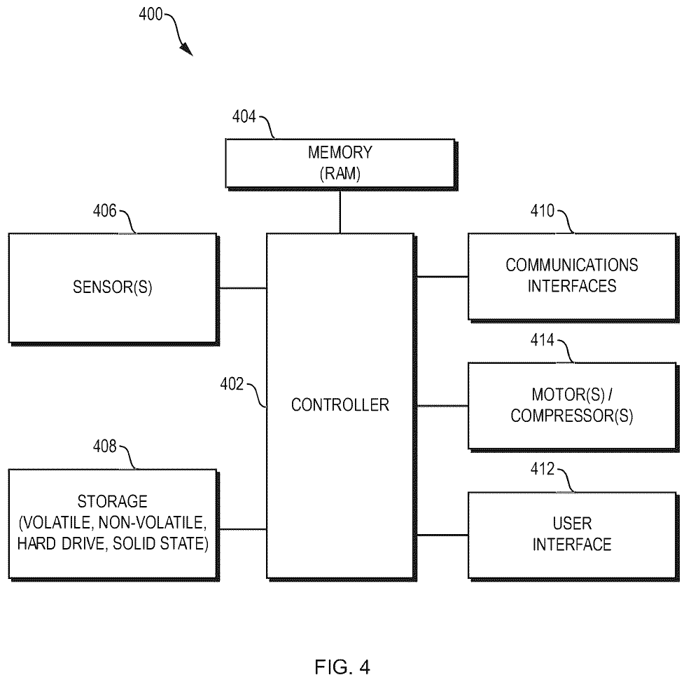

The frozen drink maker 100 may include a refrigeration circuit and/or system to provide cooling of a drink product and/or to control the temperature of a drink product within mixing vessel 104. The refrigeration circuit may include a compressor 214, an evaporator 202, a condenser 216, a condenser fan 218, a bypass valve, and conduit that carries refrigerant in a closed loop among the refrigeration circuit components to facilitate cooling and/or temperature control of a drink product in mixing vessel 104. Operations of the refrigeration circuit may be controlled by a controller, such as controller 402, as described further with respect to FIG. 4. Frozen drink maker 100 may also include a removeable collection tray 220 arranged to collect any liquid condensation caused by cooling from evaporator 202. FIG. 2 shows tray 220 in the inserted position. Tray 220 may be insertably removeable from a slot within housing 102 to enable collection of condensed liquid when inserted into the slot and then efficient removal to empty tray 220, and then re-insertion into the slot for subsequent liquid collection, as described further with respect to FIGS. 5A and 5B. Frozen drink maker 100 may also include a printed circuit board assembly (PCBA) 222 within housing 102. As will be explained with respect to FIG. 4, PCBA 222 may include a control system 400 arranged to automatically control certain operations of frozen drink maker 100.

FIG. 3 shows a front view 300 of frozen drink maker 100 of FIG. 1. Frozen drink maker 100 may include user interface 112 on a front surface of housing 102. In other implementations, user interface 112 may be located on a side, top, or back of housing 102. Frozen drink maker may include a mount 302 on a side of housing 102 where drip tray 304 can be mounted when not in use, such as during transport of frozen drink maker 100. Frozen drink maker 100 may include a power interface arranged to receive AC power from a power outlet (not shown). In some implementations, frozen drink maker 100 may include one or more batteries housed within housing 102 and arranged to provide power to various components of frozen drink maker 100.

FIG. 4 is a block diagram illustrating an example of a control system 400 of frozen drink maker 100 according to some implementations of the disclosure. Control system 400 may include a microcontroller, a processor, a system-on-a-chip (SoC), a client device, and/or a physical computing device and may include hardware and/or virtual processor(s). In some implementations, control system 400 and its elements as shown in FIG. 4 each relate to physical hardware, while in some implementations one, more, or all the elements could be implemented using emulators or virtual machines. Regardless, electronic control system 400 may be implemented on physical hardware, such as in frozen drink maker 100.

As also shown in FIG. 4, control system 400 may include a user interface 212 and/or 112, having, for example, a keyboard, keypad, one or more buttons, dials, touchpad, or sensor readout (e.g., biometric scanner) and one or more output devices, such as displays, speakers for audio, LED indicators, and/or light indicators. Control system 400 may also include communications interfaces 410, such as a network communication unit that could include a wired communication component and/or a wireless communications component, which may be communicatively coupled to controller and/or processor 402. The network communication unit may utilize any of a variety of proprietary or standardized network protocols, such as Ethernet, TCP/IP, to name a few of many protocols, to effect communications between processor 402 and another device, network, or system. Network communication units may also comprise one or more transceivers that utilize the Ethernet, power line communication (PLC), Wi-Fi, cellular, and/or other communication methods. For example, control system 400 may send one or more communications associated with a status of frozen drink maker 100 to a mobile device of a user, e.g., send an alert to the mobile device when a recipe is complete and/or a drink product is ready for dispensing, or to indicate that the mixing vessel is low or out of a drink product.

Control system 400 may include a processing element, such as controller and/or processor 402, that contains one or more hardware processors, where each hardware processor may have a single or multiple processor cores. In one implementation, the processor 402 includes at least one shared cache that stores data (e.g., computing instructions) that are utilized by one or more other components of processor 402. For example, the shared cache may be a locally cached data stored in a memory for faster access by components of the processing elements that make up processor 402. Examples of processors include but are not limited to a central processing unit (CPU) and/or microprocessor. Controller and/or processor 402 may utilize a computer architecture base on, without limitation, the Intel® 8051 architecture, Motorola® 68HCX, Intel® 80×86, and the like. The processor 402 may include, without limitation, an 8-bit, 12-bit, 16-bit, 32-bit, or 64-bit architecture. Although not illustrated in FIG. 4, the processing elements that make up processor 402 may also include one or more other types of hardware processing components, such as graphics processing units (GPUs), application specific integrated circuits (ASICs), field-programmable gate arrays (FPGAs), and/or digital signal processors (DSPs).

FIG. 4 also illustrates that memory 404 may be operatively and communicatively coupled to controller 402. Memory 404 may be a non-transitory medium configured to store various types of data. For example, memory 404 may include one or more storage devices 408 that include a non-volatile storage device and/or volatile memory. Volatile memory, such as random-access memory (RAM), can be any suitable non-permanent storage device. The non-volatile storage devices 408 may include one or more disk drives, optical drives, solid-state drives (SSDs), tape drives, flash memory, read-only memory (ROM), and/or any other type of memory designed to maintain data for a duration time after a power loss or shut down operation. In certain configurations, the non-volatile storage devices 408 may be used to store overflow data if allocated RAM is not large enough to hold all working data. The non-volatile storage devices 408 may also be used to store programs that are loaded into the RAM when such programs are selected for execution. Data store and/or storage devices 408 may be arranged to store a plurality of drink product making and/or processing instruction programs associated with a plurality of drink product processing sequences, i.e., recipes. Such drink product making and/or processing instruction programs may include instruction for controller and/or processor 402 to: start or stop one or motors and/or compressors 414 (e.g., such as motor 208 and/or compressor 214), start or stop compressor 214 to regulate a temperature of a drink product being processed within mixing vessel 104, operate the one or more motors 414 (e.g., motor 208 and/or compressor 214) at certain periods during a particular drink product processing sequence, operate motor 208 at certain speeds during certain periods of time of a recipe, issue one or more cue instructions to user interface 412 and/or 112 that are output to a user to illicit a response, action, and/or input from the user.

In operation in certain implementations, a user fills mixing vessel 104 via pour-in opening 106 with ingredients associated with a drink product. The user selects the type of drink product to be processed via user interface 112, e.g., the user selects the recipe for “margarita.” In some implementations, the user selects the product type and/or recipe before filling the mixing vessel 104 and the user interface 112 provides one or more indicators or queues (visible and/or audible) that instruct the user to add ingredients to mixing vessel 104. Mixing vessel 104 may include one or more fill sensors that detect when a sufficient amount or level of ingredients and/or fluid is within mixing vessel 104. The one or more fill sensors may provide a signal to processor 402 that indicates when vessel 104 is sufficiently filled or not filled. Processor 402 may prevent operations of the frozen drink maker 100 (e.g., prevent activation of motor 208 and/or other components) if the fill sensor(s) 406 indicate that vessel 104 is not sufficiently filled. A lid sensor may be associated with opening 106 whereby the lid sensor sends an open and/or closed signal to processor 402 that indicates whether opening 106 is open or closed. Processor 402 may prevent operations of the frozen drink maker 100 if the lid sensor indicates that opening 106 is open and/or not closed. Depending on the sensed condition, user interface 112 may provide an indication regarding the condition, e.g., that vessel 104 is sufficiently filled or not sufficiently filled and/or that opening 106 is not closed, to enable a user to take appropriate action(s).

Once mixing vessel 104 is filled with ingredients, the user may provide an input, e.g., a button press, to start processing of the drink product based on the selected recipe. Processing may include activation of motor 208 to drive rotation of dasher 204 and/or blade 206 to effect mixing of the ingredients of the drink product. Processing may also include activation of the refrigeration system including activation of compressor 214 and condenser fan 218. The compressor 214 facilitates refrigerant flow through one or more coils of evaporator 202 and through condenser 216 to provide cooling and/or temperature control of the drink product within mixing vessel 104. Processor 402 may control operations of various components such as motor 208 and compressor 214. To regulate temperature at a particular setting associated with a recipe, processor 402 may activate/start and/or de-activate/stop compressor 214 to start and/or stop refrigerant flow through the coil(s) of evaporator 202 and, thereby, start or stop cooling of the drink product within mixing vessel 104.

By cooling a drink product to a particular temperature, slush and/or ice particles may be formed within the drink product. Typically, the number of particles and/or texture of a drink product corresponds to a temperature of the drink product, i.e., the cooler the temperature—the larger the number of particles (and/or the larger the size of particles) and/or the more slushy the drink product. User interface 112 may enable a user to fine tune and/or adjust a preset temperature associated with a recipe to enable a user to adjust the temperature and/or texture of a drink product to a more desirable temperature and/or texture.

Processor 402 may perform processing of the drink product for a set period of time in one or more phases and/or until a desired temperature and/or texture is determined. Processor 402 may receive one or more temperature signals from one or more temperature sensors 408 within mixing vessel 104 to determine the temperature of the drink product. Processor 402 may determine the temperature of the drink product by determining an average temperature among temperatures detected by multiple temperature sensors 408. Processor 402 may determine the temperature of the drink product based on the detected temperature from one sensor 408 within mixing vessel 104 and/or based on a temperature of the refrigerant detected by a refrigerant temperature sensor 408. Once a phase and/or sequence of a recipe is determined to be completed by processor 402, processor 402 may, via user interface 112, provide a visual and/or audio indication that the recipe is complete and ready for dispensing. In response, a user may place a cup or container below dispenser assembly 108 and pull handle 120 rotationally downward towards the user to open a spout located at the lower front wall of mixing vessel 104, resulting in dispensing of the drink product into the cup or container. Once filled, the user can close the spout by pushing handle 120 back rotationally upward away from the user to its upright position shown in FIG. 2. In implementations where handle 120 is spring biased to the closed position, the user can release their hold of handle 120 and, thereby, allow a spring force to move handle 120 back rotational upward away from the user to the upright and closed position.

FIGS. 5A and 5B show a dispensing assembly 500 for dispensing a drink product from the frozen drink maker 100 according to an illustrative implementation of the disclosure.

As shown in FIG. 5A, the dispensing assembly 500 may include a dispenser housing 504 for housing the component parts of the dispensing assembly 500. The housing 504 may have a first portion 504a attached to a vertical front panel 105 of the frozen drink maker 100 adjacent to a spout 502 and a second portion 504b spaced apart from the spout 502 and extending outward from the vertical front panel 105. The spout 502 may be configured to dispense the drink product in a substantially horizontal direction. The handle 120 may have an upper portion 120a in the form of a user-actuatable lever 506 and a lower portion 120b attached to the second portion 504b of the housing 504. The lever 506 may be rotatable relative to the second portion 504b of the housing 504 about a first pivot member 508. A link member 512 may operatively couple to the lower portion 120b of the handle 120. The link member 512 may be rotatable relative to the lever 506 about a second pivot member 514.

As shown in FIG. 5B, a bracket member 518 may operatively couple to the link member 512 and may be attached to the first portion 504a of the housing 504. In some implementations, the bracket member 518 may have an inverted L-shape, as shown. However, the disclosure contemplates other suitable shapes of the bracket member 518. The bracket member 518 may be rotatable relative to the link member 512 about a third pivot member 520. The bracket member 518 may also be rotatable relative to the first portion 504a of the housing 504 about a fourth pivot member 524. A seal 528 may attach to the bracket member 518. The seal 528 may be configured to seal the spout 502 in a closed position. In some implementations, the seal 528 may be a lip seal that covers the spout 502. However, in some implementations, the seal 528 may be, or may include, a plug that is made out of one or more relatively dense materials having a relatively high durometer and that extends into the spout 502 to seal the spout 502.

To dispense the drink product, in some implementations, actuation of the lever 506 by the user may cause the link member 512 to move upward relative to the housing 504. Because the bracket member 518 is attached to both the link member 512 and to the housing 504, a portion of the bracket member 518 may move upward with the link member 512 while the remainder of the bracket member 518 is forced to pivot about fourth pivot member 524. This in turn may cause the seal 528 to move into an open position. When the seal 528 moves into the open position, the seal 528 may uncover the spout 502 to dispense the drink product in a substantially horizontal direction. However, in the open position, the seal 528 may be angled at about 45 to 60 degrees with respect to the spout 502 to direct the drink product downward toward the beverage cup. Release of the lever 506 by the user may allow the components to return to their unactuated position, allowing the seal 528 to again close the spout 602.

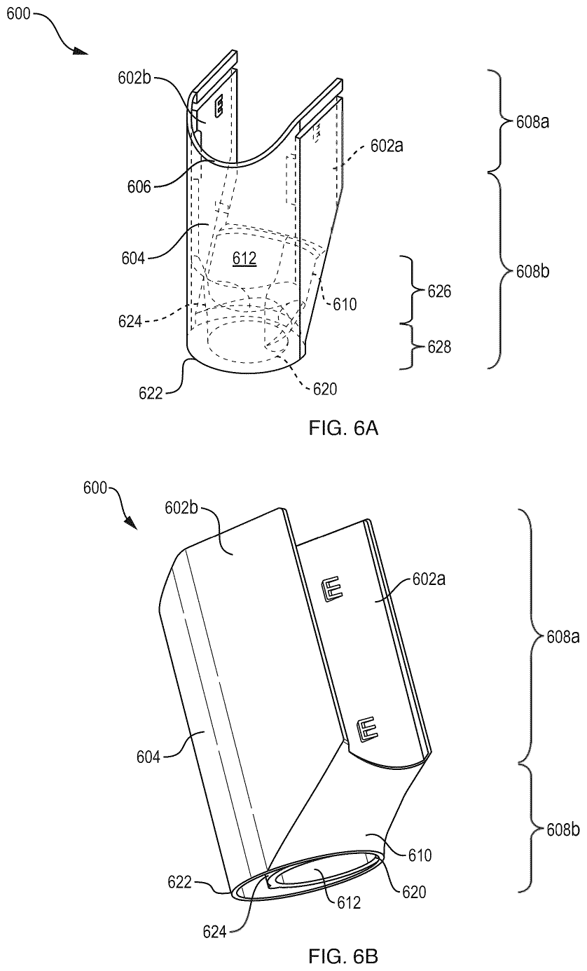

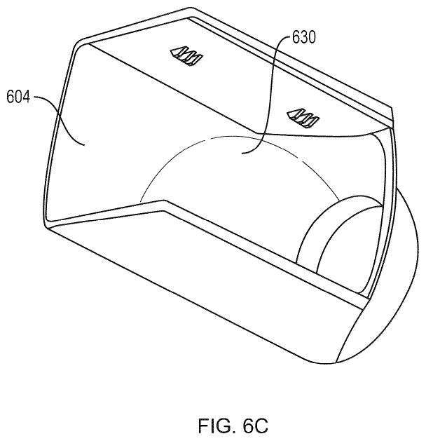

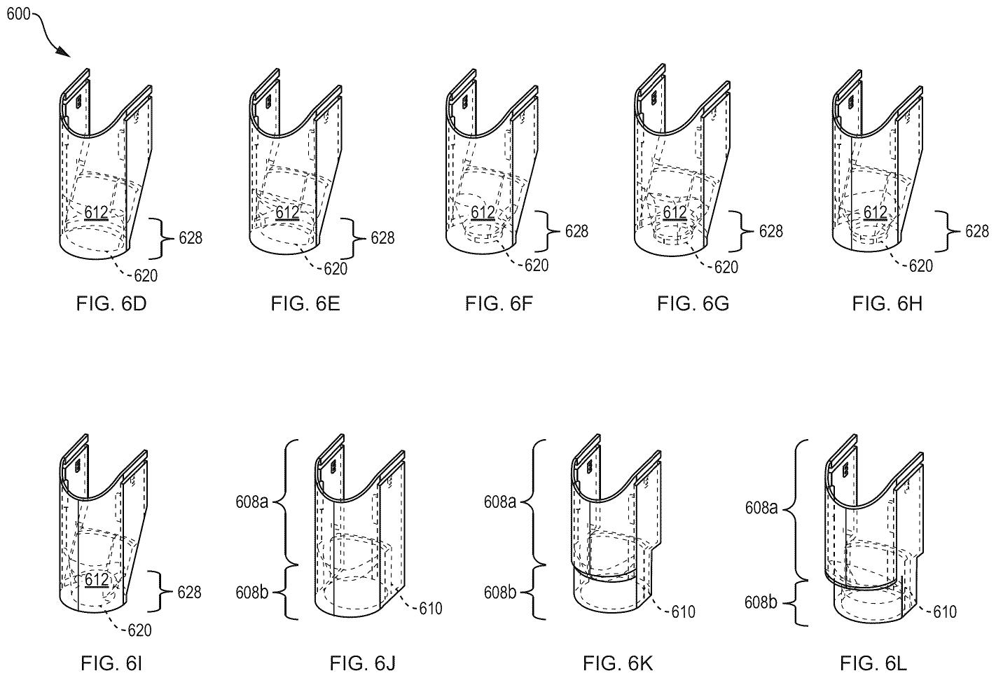

FIGS. 6A and 6B show a dispensing funnel 600 (e.g., spout cover 116) for dispensing a drink product from a frozen drink maker (e.g., frozen drink maker 100) according to some implementations of the disclosure. The funnel 600 may be configured to cover a dispensing assembly (e.g., dispensing assembly 500) to dispense the drink product from the frozen drink maker 100 in a clean, predictable, and visually appealing manner. The funnel 600 may be molded into a unitary piece or may be assembled from multiple pieces. The funnel 600, or parts thereof, may be made from a transparent or an opaque material.

As shown in FIGS. 6A and 6B, the funnel 600 may include a first panel section 602a and a second panel section 602b extending substantially parallel to the first panel section 602a. A front section 604 may extend between the panel sections 602a, 602b. In some implementations, the panel sections 602a, 602b may be substantially flat, while the front section 604 may be curved, as shown. However, the disclosure contemplates that the front section 604 may have other configurations, such as flat or triangular. In some implementations, the front section 604 may include an arcuate upper edge 606 configured such that actuation of the handle 120 is not impeded. However, the disclosure contemplates other suitable shapes of the upper edge 606, such as the rectilinear shape shown in FIG. 1. The panel sections 602a, 602b may be configured to form a removable snap fit with the dispenser housing 504 of the dispensing assembly 500. A length of the front section 604 may be selected to cover the component parts of the dispensing assembly 500 (other than the handle 120) to improve the aesthetic appearance of the frozen drink maker 100. The funnel 600 may be made of a transparent, food safe, and dishwasher safe material.

In some implementations, the funnel 600 may have an upper portion 608a that is attachable to the dispenser housing 504 and configured to sit flush with the vertical front panel 105 of the frozen drink maker 100. A lower portion 608b may extend downward from the upper portion 608a. The lower portion 608b may include an inner wall 610 defining an internal channel 612 that may be configured to be positioned below the spout 502 when the funnel 600 is attached to the dispensing assembly 500. The inner wall 610 may extend at an angle relative to the vertical front panel 105 of the frozen drink maker 100. In some implementations, the inner wall 610 may extend at an angle of between 15 and 40 degrees (e.g., 30 degrees) relative to the vertical front panel 105. The inner wall 610 may further at least partially define a dispenser opening 620 at the end of the channel 612 as well as a funnel opening 622 formed with the front section 604. The dispenser opening 620 may further be at least partially defined by an outer wall 624 extending substantially parallel to the vertical front panel 105. Thus, the channel 612 may have a first region 626 directing flow of the drink product an angle relative to the vertical front panel 105 and a second region 628 directing flow of the drink product parallel to the vertical front panel 105. In this way, the channel 612 may be configured to direct a flow of the drink product from the spout 502 (i.e., in a horizontal direction) through the dispenser opening 620 in a substantially vertically downward direction.

As shown in FIG. 6C, the channel 612 may further include a chamfer region 630 extending from the front section 604. When the drink product is dispensed from the spout 502, the drink product may initially contact the chamfer region 630. Thus, an angle of the chamfer region 630 relative to the front section 604 may direct splashing of the drink product upward so that the drink product does not splash backward and leak out between the funnel 600 and the drink maker 100.

In some implementations, a shape of the dispenser opening 620 may be circular. However, the disclosure contemplates other shapes of the opening 620, such as oval or eye shaped. In some implementations, a diameter of the of the dispenser opening 620 may be selected to be larger than the diameter of the spout 502 so that the flow rate of the drink product out of the dispenser opening 620 is faster than the flow rate of the drink product into the funnel 600 to avoid buildup of the drink product inside the funnel 600. For example, a diameter of the opening 620 may be selected to be between 5% and 20% larger than a diameter of the spout 502. Thus, an internal diameter of the channel 612 may gradually widen between the spout 502 and the dispenser opening 620. The configuration of the channel 612 may therefore allow free flow of the drink product while preventing the drink product from getting clogged near the spout 502. Furthermore, the larger dispenser opening 620 relative to the spout 502 allows the user to more accurately predict where to place a drink cup to catch the dispensed drink product.

One of skill in the art will appreciate that various implementations of the funnel 600 can have different shapes and geometries, while still providing the benefits of a cleaner, more predictable, and more aesthetically pleasing drink product dispense. For example, as shown in FIGS. 6D-61, the dispenser opening 620 can have various shapes and sizes, and the lower region 628 of the channel 612 may have various configurations. As shown in FIGS. 6J-6L, the inner wall 610 may extend substantially parallel to the front panel 105, rather than at an angle, and the lower portion 608b of the funnel 600 may have various configurations relative to the upper portion 608a.

One of skill in the art will also appreciate that the various implementations described herein are not limited to making frozen or semi-frozen drinks but may be applied to produce a cold and/or cooled drink product that is cooler than a received drink product, but not frozen or semi-frozen. For example, in some implementations, the same or similar mechanisms and/or techniques may be used as part of a cold drink machine and/or cooled drink maker to produce, maintain and dispense cold drinks.

Elements of different implementations described may be combined to form other implementations not specifically set forth previously. Elements may be left out of the systems described previously without adversely affecting their operation or the operation of the system in general. Furthermore, various separate elements may be combined into one or more individual elements to perform the functions described in this specification.

1. A funnel for covering a dispenser assembly of a frozen drink maker, the funnel comprising:
an upper portion configured to cover a spout of the frozen drink maker that dispenses a drink product from the frozen drink maker in a horizontal direction; and
a lower portion extending downward from the upper portion, the lower portion including an inner wall defining a channel, the channel including a first region configured to direct a flow of the drink product at an angle relative to a front panel of the frozen drink maker, and a second region configured to direct the flow of the drink product in an at least substantially vertically downward direction.

2. The funnel of claim 1, wherein the funnel is configured to position the channel below the spout.

3. The funnel of claim 1, wherein the angle is between about 15 and 40 degrees relative to the front panel.

4. The funnel of claim 1, wherein the second region of the channel includes a dispenser opening.

5. The funnel of claim 4, wherein the channel is configured to direct the flow of the drink product from the spout through the dispenser opening.

6. The funnel of claim 4, wherein a diameter of the dispenser opening is selected to be wider than a diameter of the spout.

7. The funnel of claim 4, wherein a diameter of the dispenser opening is between about 5% and 20% wider than a diameter of the spout.

8. The funnel of claim 4, wherein a shape of the dispenser opening is circular.

9. The funnel of claim 1, wherein the second region of the channel is at least partially defined by the inner wall.

10. The funnel of claim 1, wherein the second region of the channel is further defined by an outer wall extending substantially parallel to the front panel.

11. The funnel of claim 1, wherein the front panel of the frozen drink maker is arranged in an at least substantially vertically downward direction.

12. The funnel of claim 1, wherein the upper portion of the funnel is removably attachable to a dispenser assembly of the frozen drink maker.
